(19) United States
(12) Patent Application Publication
(10) Pub. No.: US 2010/0093206 A1
(43) Pub. Date: Apr. 15, 2010

(54) Electrical connector for electrical communication between a power cable and an electrical device

(75) Inventor: Tsang Hon Chuen, Shatin (HK)

Correspondence Address: YH CHAN, 42 PIN OAKS DRIVE, PHOENIXVILLE, PA, 19460, US

(73) Assignee: Checkson Die Casting and Product Factory Limited, Shatin (HK)

(21) Appl. No.: 12/252,356

(22) Filed: Oct. 15, 2008

(51) Int. Cl. H01R 4/24

(52) U.S. Cl. 439/391

(57) ABSTRACT

An electrical connector for electrical communication between a power cable and an electrical device comprising a tubular housing, one end of which having a longitudinal channel for receiving the power cable as defined by the flanges one on each side having a threaded radically outward surface, and the other end of which having a receptacle for receiving a two-pin or three-pin plug of the electrical device and after plugging the two electrically conductive contacts of the plug each connects to one or more stabs which are electrically conductive and extend from the channel for piercing the power cable; and a cap having a threaded interior surface for engaging with the threaded outward surfaces of the flanges and having a pressing member attached onto the interior bottom surface of the cap for being received within the channel for pressing against the cable in the channel. The present invention is convenient to use and is adapted for use with a low voltage or high voltage power source.

### BACKGROUND OF THE INVENTION

The present invention relates to electrical connectors and more particularly pertains to electrical connectors which are used to connect multiple electrical devices to a power cable without stripping the cable insulation or soldering the wires of the cable and the electrical devices together such that the power cable transmits power from a power source to the electrical devices.

In general, these electrical connectors are used for outdoor lighting. An outdoor lighting system may be built with a number of these electrical connectors which connect to a cable for electrical communication and the cable connects to a power source such as an outdoor electrical socket, and each electrical connector connects to an outdoor lighting fixture. For safety, the lighting fixtures are low voltage lights and a transformer that changes high voltage power to low voltage power is connected in between the power source and the cable to turn the system into a low voltage system.

A conventional electrical connector of the known art, as shown in FIG. 1, is in the form of a box 1′ which has two channels 11′, 12′ each with a pair of stabs 13′, 14′ generally made of copper extended from a surface of the respective channel and pointed upward, and one of the channels is for receiving the cable for electrical communication and the other is for receiving the cable of an electrical device, and each stab pierces the centre of a cable for electrical communication so that one pair of stabs pierce the wires in the cable with one stab for one of the two wires therein and the other pair pierce the cable of the electrical device also with one stab for one of the two wires therein, and the box is covered by a lid 2′ and the lid is tightened onto the top of the box by means of two screws 3′ and three to four screws in some other electrical connectors. A pressing member, not shown in FIG. 1, may be added in between the lid and the cables so as to push the cables forcibly into the channels for piercing by the stabs to establish better electrical communication. If an electrical device has to be disconnected or reconnected to another position of the cable for electrical communication, the original pierced holes in the cables may be wrapped with electrical tapes.

The prior art also provides improved electrical connectors. As shown in FIG. 2, an improved electrical connector comprises a base 1″ and a cap 2″ which can engage with the base by screwing. The base has a longitudinal channel with a pair of spaced-apart stabs 11″ for receiving and piercing the cable for electrical communication. A pair of passages 12″ is provided in the base extending from the stabs to a side wall of the base for the wires of an electrical device to be inserted one each through the passages into contact with the stabs for electrical communication. A pair of threaded axial bores 13″ is provided extending from the stabs to a surface of the base for receiving a pair screws 3″ into the bores one each. The screws therefore secure the wires of the electrical device with the stabs. A presser 4″ is also provided on the interior bottom surface of the cap for pressing against the cable in the channel. A positioner 5″ is further provided having a substantial U-shaped cross-section for being received within the channel over a cable for accommodating a cable of an insufficient thickness.

In comparison with the conventional electrical connector, the said improved electrical connector requires less effort and force to establish and to re-establish the electrical communication. However, the said improved electrical connector is more complicated in construction having more parts and components and is therefore susceptible of higher production costs. Further, both the conventional electrical connector and the said improved electrical connector are only adapted for use with power sources of low voltage electricity.

### BRIEF SUMMARY OF THE INVENTION

In view of the aforesaid disadvantages now present in the prior art, the object of the present invention is to provide an electrical connector for electrical communication between a power cable and an electrical device which is convenient to use and is adapted for use with a low voltage or high voltage power source.

To attain this, the present invention adopts the following technical proposal:

An electrical connector for electrical communication between a power cable and an electrical device comprises a tubular housing, one end of which having a longitudinal channel for receiving the power cable as defined by the flanges one on each side having a threaded radically outward surface, and the other end of which having a receptacle for receiving a two-pin or three-pin plug of the electrical device and after plugging the two electrically conductive contacts of the plug each connects to one or more stabs which are electrically conductive and extend from the channel for piercing the power cable; and a cap having a threaded interior surface for engaging with the threaded outward surfaces of the flanges and having a pressing member attached onto the interior bottom surface of the cap for being received within the channel for pressing against the cable in the channel.

The present invention further comprises a connecting member, one end of which is attached onto the housing and the other end of which is attached onto the cap for avoiding the cap from being misplaced or otherwise lost, and the length of which is sufficient to allow the cap to be separated from the housing by screwing.

The present invention further comprises a fastening ring which is disposed with a threaded interior surface surrounding the other end of the housing. The receptacle at the other end of the housing is disposed with a threaded outward surface for engaging with the threaded interior surface of the fastening ring such that the fastening ring moves downward to cover a section of the cable of the electrical device after its plug is being plugged into the receptacle for avoiding accidental disconnection and for making the connection weatherproof.

The present invention further comprises an adjusting member having a substantial U-shaped cross-section for being received within the channel for adjusting the size of the channel for receiving a cable of an insufficient thickness.

More than one electrical connectors of the present invention can be connected to the power cable to form a power supply system to supply electricity to the electrical devices each of which is connected to one of the electrical connectors.

The present invention operates as follows:

A power cable which is connected to a supply of electricity is placed in the channel. If the cable is of an insufficient thickness, an adjusting member can be placed in the channel and then the cable can be placed in the adjusting member. The cap is then screwed onto the housing by engaging the threaded interior surface of the cap with the threaded outward surfaces of the flanges and by so doing the pressing member attached onto the interior bottom surface of the cap will press against the cable in the channel, and the stabs extending from the channel will pierce the power cable. An electrical device such as a lamp or a hairdryer can then be connected by simply inserting the plug of the electrical device into the receptacle of the housing and after plugging the two electrically conductive contacts of the plug connect to the stabs. If a fastening ring is provided, it can be screwed to engage its threaded interior surface with the threaded outward surface of the receptacle of the housing so that the fastening ring moves downward to cover a section of the cable of the electrical device for avoiding accidental disconnection and for making the connection weatherproof. When there is a supply of electricity, the power cable will transmit the electricity through the electrically conductive stabs and the two electrically conductive contacts of the plug to the electrical device.

A plurality of the present invention may be used together to form a power supply system for example for hairdryers in a hair salon or for lamps in a room or for outdoor lighting fixtures.

If an electrical device has to be replaced, its plug may simply be plugged out from the receptacle. If a new or replacement electrical device has to be connected to the power supply system, the plug of the new or replacement electrical device may simply be plugged into the receptacle. If the present invention has to be removed or relocated owing to reasons such as relocation of the electrical device or even the power cable, the plug of the electrical device may simply be plugged out and the cap be screwed out to separate from the housing so that the power cable can be taken out of the channel and the pierced holes in the cable may be wrapped with a tape. Then, after the electrical device or the power cable is relocated, the power cable is placed in the channel, the cap is screwed onto the housing and the plug of the electrical device is plugged into the receptacle.

The advantages of the present invention are that in comparison with the prior art the present invention is more convenient to use as no screws are required and the plug of the electrical device may simply be plugged into the receptacle. The connecting member of the present invention can effectively avoid the cap from being misplaced or otherwise lost. The fastening ring can cover a section of the cable of the electrical device after its plug is being plugged into the receptacle for avoiding accidental disconnection and for making the connection weatherproof. The connection of the cap with the housing by means of screwing can also avoid accidental disconnection and make the connection weatherproof. This construction highly increases the safety level and the present invention is therefore adapted for use with a high voltage power source as well unlike the prior art.

### BRIEF DESCRIPTION OF THE DRAWINGS

FIG. 1 is an exploded view of a conventional electrical connector of the prior art.

FIG. 2 is a schematic view of an improved electrical connector of the prior art.

FIG. 3 is a perspective view showing the first embodiment of the present invention.

FIG. 4 is a cross-sectional view showing the first embodiment when the cap is disengaged from the housing.

FIG. 5 is a cross-sectional view showing the first embodiment when the cap is engaged with the housing.

FIG. 6 is a perspective view showing the cap, the connecting member, the housing and the fastening ring of the first embodiment from a top angle.

FIG. 7 is another perspective view showing the cap, the connecting member, the housing and the fastening ring of the first embodiment from a bottom angle.

FIG. 8 is a perspective view showing how the power cable and the electrical device are connected with the first embodiment.

FIG. 9 is a schematic view showing how the first embodiment is used in establishing a power supply system for lamps.

FIG. 10 is a schematic view showing how the first embodiment is used in establishing a power supply system for hairdryers.

FIG. 11 is a cross-sectional view showing the second embodiment when the cap is disengaged from the housing.

FIG. 12 is a cross-sectional view showing the second embodiment when the cap is engaged with the housing.

FIG. 13 is a perspective view showing the cap, the connecting member, the adjusting member, the housing and the fastening ring of the second embodiment from a top angle.

FIG. 14 is another perspective view showing the cap, the connecting member, the adjusting member, the housing and the fastening ring of the second embodiment from a bottom angle.

FIG. 15 is a schematic view showing how the second embodiment is used in establishing a power supply system for hairdryers with a power cable of an insufficient thickness.

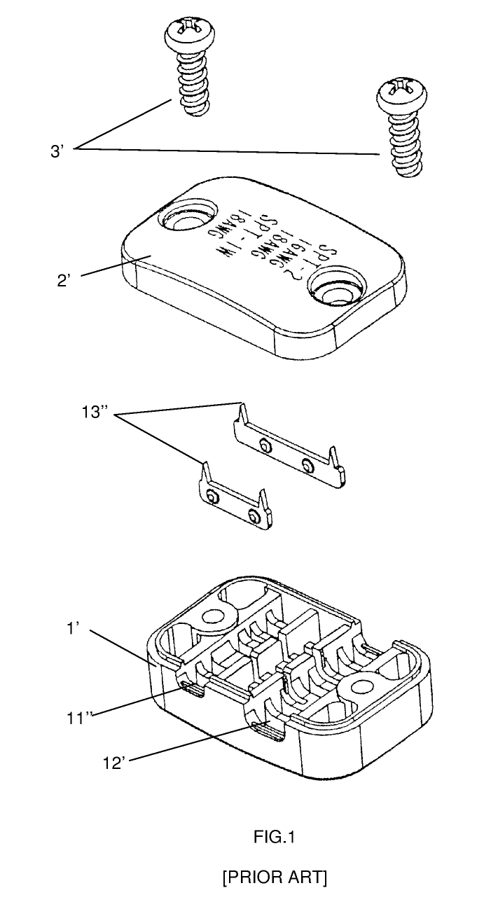

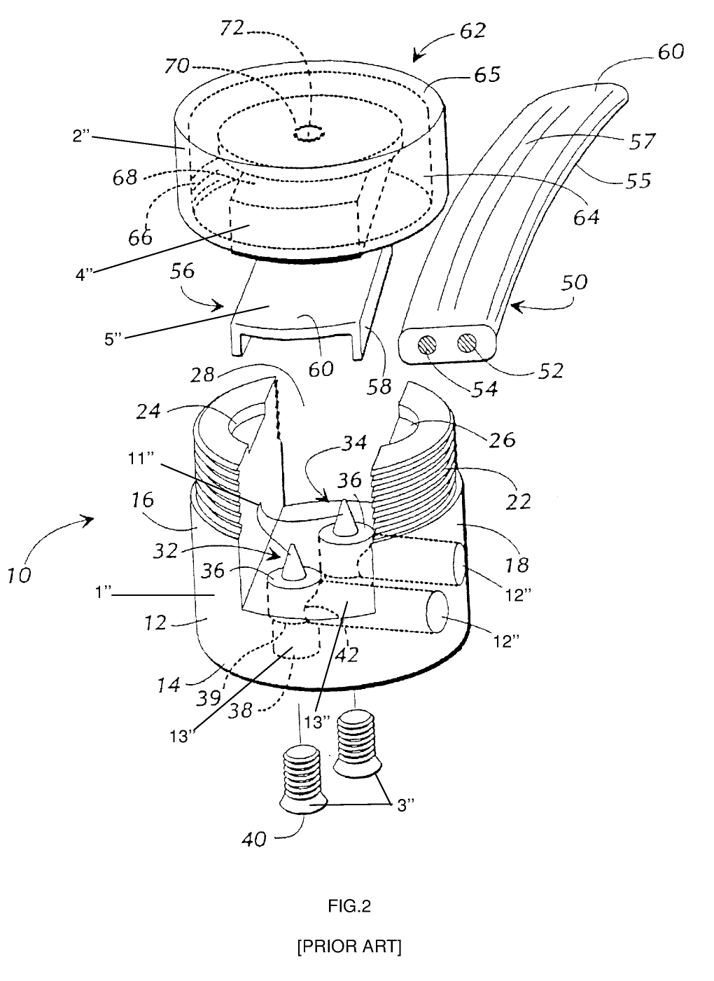

### DETAILED DESCRIPTION OF THE INVENTION

The preferred embodiments of the present invention are further described in detail with the following embodiments and the accompanying drawings.

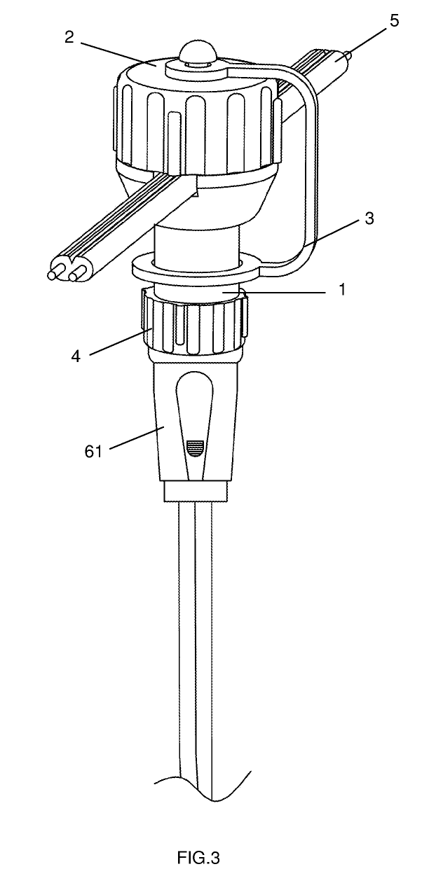

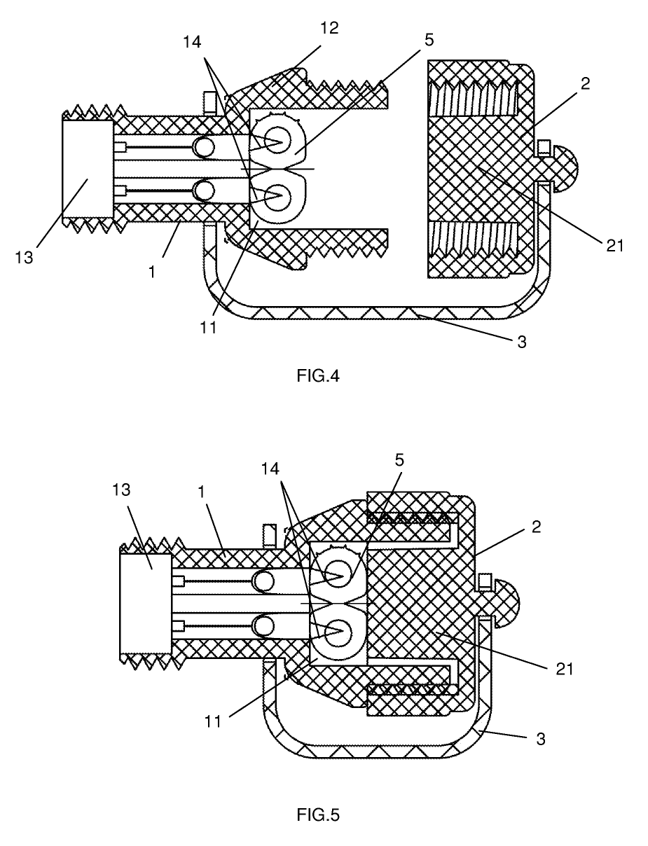

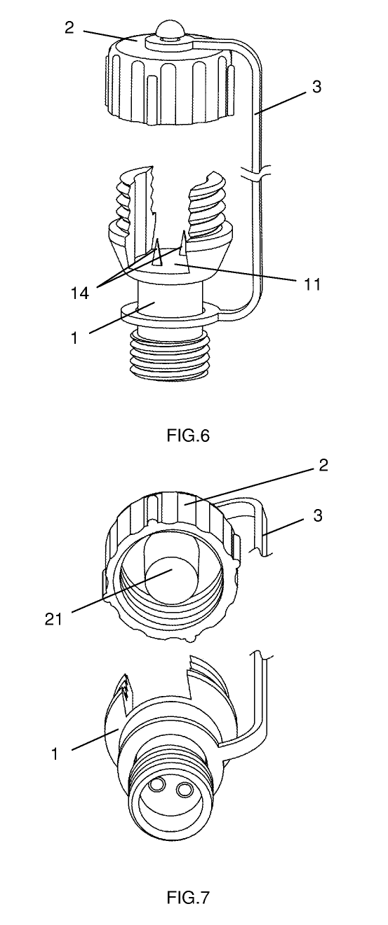

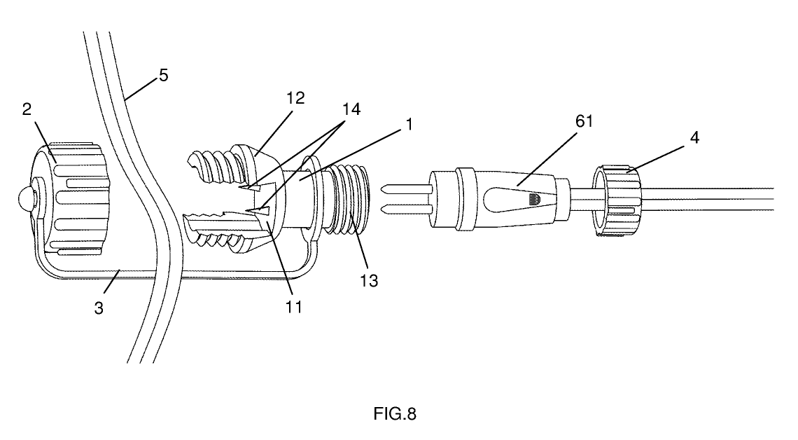

FIGS. 3 to 10 illustrates the construction of an electrical connector of the first embodiment of the present invention. The electrical connector of the present invention is for electrical communication between a power cable 5 and an electrical device 6 and it comprises a tubular housing 1, one end of which having a longitudinal channel 11 for receiving the power cable 5 as defined by the flanges 12 one on each side having a threaded radically outward surface, and the other end of which having a receptacle 13 for receiving a two-pin plug 61 of the electrical device 6 and after plugging the two electrically conductive contacts of the plug 61 each connects to two stabs 14 which are electrically conductive and extend from the channel 11 for piercing the power cable 5; and a cap 2 having a threaded interior surface for engaging with the threaded outward surfaces of the flanges 12 and having a pressing member 21 attached onto the interior bottom surface of the cap 2 for being received within the channel 11 for pressing against the cable 5 in the channel 11. In the other embodiments, the plug 61 can be a three-pin plug and the number of the stabs 14 can be any number other than two.

As in FIGS. 3 to 10, the electrical connector of this embodiment further comprises a connecting member 3, one end of which is attached onto the housing 1 and the other end of which is attached onto the cap 2 for avoiding the cap 2 from being misplaced or otherwise lost, and the length of which is sufficient to allow the cap 2 to be separated from the housing 1 by screwing.

As in FIGS. 3 and 8 to 10, the electrical connector of this embodiment further comprises a fastening ring 4 which is disposed with a threaded interior surface surrounding the other end of the housing 1. The receptacle 13 at the other end of the housing 1 is disposed with a threaded outward surface for engaging with the threaded interior surface of the fastening ring 4 such that the fastening ring 4 moves downward to cover a section of the cable of the electrical device 6 after its plug 61 is being plugged into the receptacle 13 for avoiding accidental disconnection and for making the connection weatherproof.

As in FIGS. 3 to 10, the power cable 5 which is connected to a supply of electricity is placed in the channel 11. The cap 2 is then screwed onto the housing 1 by engaging the threaded interior surface of the cap 2 with the threaded outward surfaces of the flanges 12 and by so doing the pressing member 21 attached onto the interior bottom surface of the cap 2 will press against the cable 5 in the channel 11, and the stabs 14 extending from the channel 11 will pierce the power cable 5. An electrical device 6 such as a lamp or a hairdryer can then be connected by simply inserting the plug 61 of the electrical device 6 into the receptacle 13 of the housing 1 and after plugging the two electrically conductive contacts of the plug 61 connect to the stabs 14. The fastening ring 4 can be screwed to engage its threaded interior surface with the threaded outward surface of the receptacle 13 of the housing 1 so that the fastening ring 4 moves downward to cover a section of the cable of the electrical device 6 for avoiding accidental disconnection and for making the connection weatherproof. When there is a supply of electricity, the power cable 5 will transmit the electricity through the electrically conductive stabs 14 and the two electrically conductive contacts of the plug 61 to the electrical device 6.

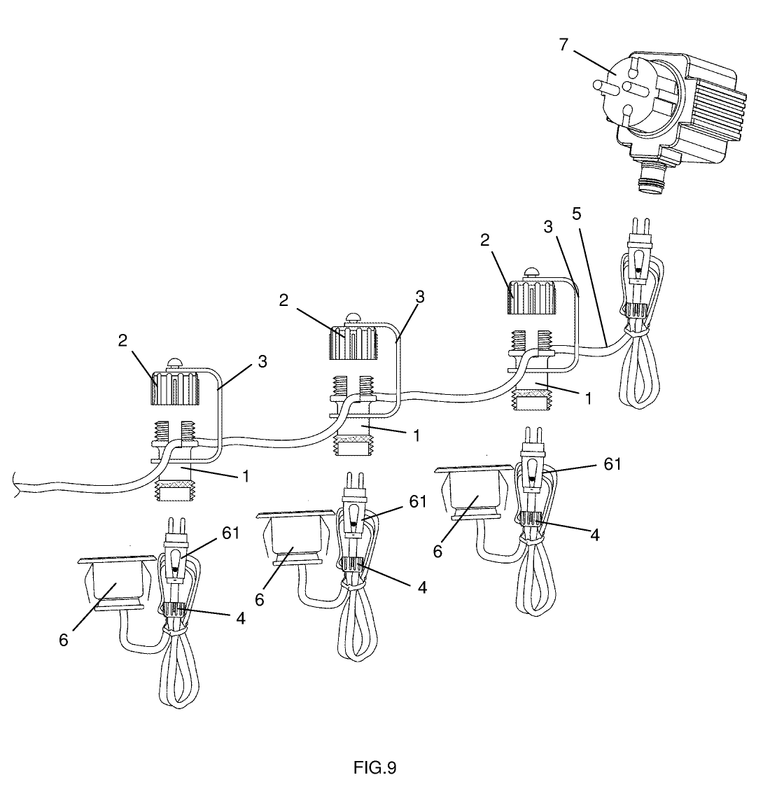

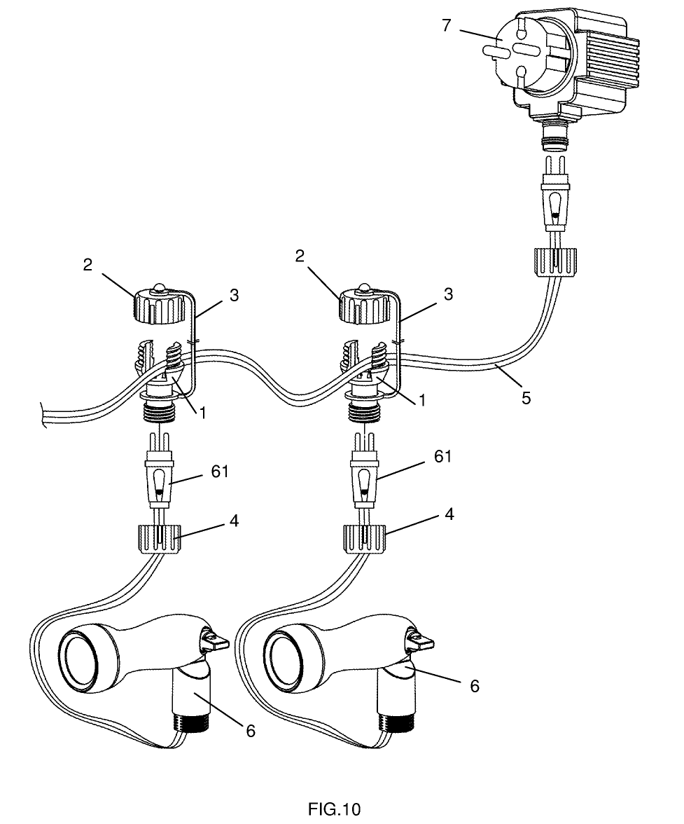

As in FIGS. 9 to 10, in other embodiments more than one electrical connectors of the present invention can be connected to the power cable 5 to form a power supply system to supply electricity to the electrical devices 6 each of which is connected to one of the electrical connectors. In the embodiment as shown in FIG. 9, the electrical devices 6 are a plurality of ceiling lights for a room. The power cable 5 is connected to a transformer 7 which regulates the voltage. In other embodiments, the electrical devices 6 are a plurality of outdoor lighting fixtures and the power cable 5 is connected to a transformer 7 which changes high voltage power to low voltage power and turn the system into a low voltage system suitable for outdoor electrical communication. The electrical connectors of the present invention are adapted for use with a low voltage or high voltage power source.

As in FIG. 10, in this embodiment the electrical devices 6 are a plurality of hairdryers. The power supply system of this embodiment is for use in a hair salon.

When an electrical device 6 in a power supply system formed by several electrical connectors of the present invention has to be replaced, its plug 61 may simply be plugged out from the receptacle 13 of the electrical connector in question. When a new or replacement electrical device 6 has to be connected to the power supply system, the plug 61 of the new or replacement electrical device 6 may simply be plugged into the receptacle 13. It is convenient to remove an old electrical device 6 and to replace a new electrical device 6.

When an electrical connector of the present invention has to be removed or relocated owing to reasons such as relocation of one of the electrical devices 6 or even the power cable 5, the plug 61 of the electrical device 6 in question may simply be plugged out and the cap 2 of the electrical connector in question be screwed out to separate from the housing 1 so that the power cable 5 can be taken out of the channel 11 and the pierced holes in the cable 5 may be wrapped with a tape. Then, after the electrical device 6 or the power cable 5 is relocated, the power cable 5 is placed in the channel 11, the cap 2 is screwed onto the housing 1 and the plug 61 of the electrical device 6 is plugged into the receptacle 13. It is convenient to relocate any electrical devices 6 or even the power cable 5.

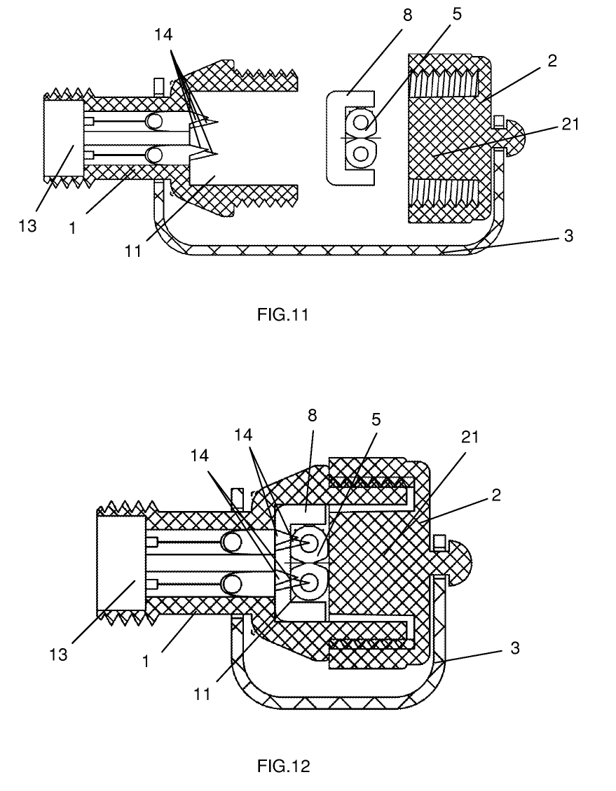

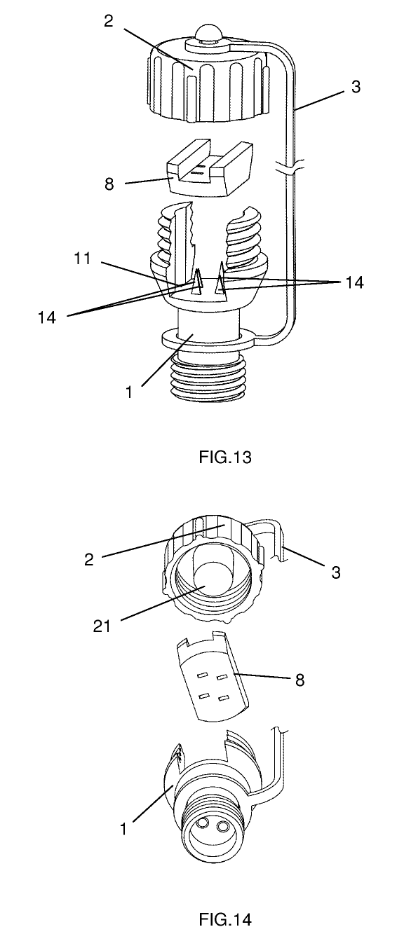

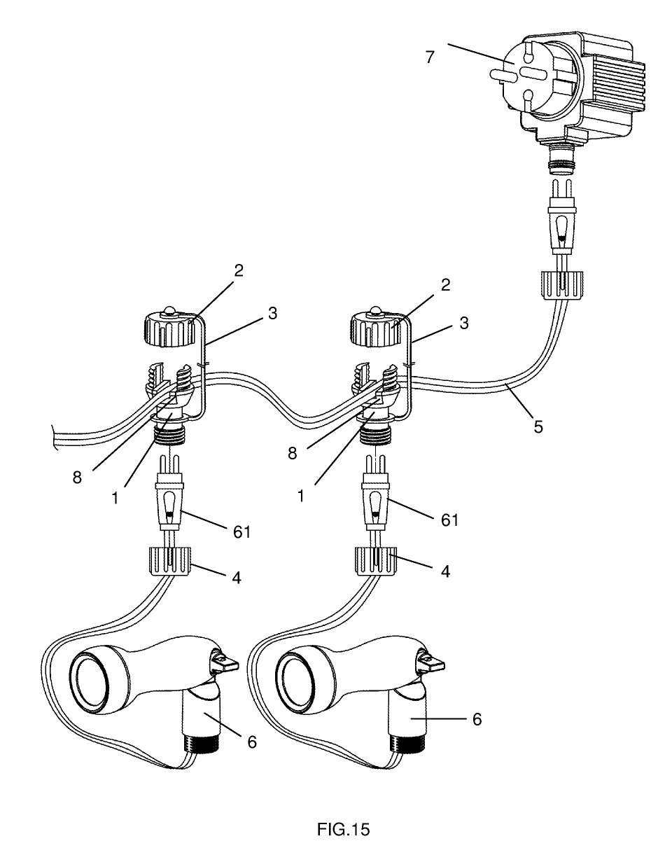

FIGS. 11 to 15 illustrates the construction of an electrical connector of the second embodiment of the present invention. The construction of this embodiment is similar to that of the first embodiment, save that as shown in FIGS. 11 to 15, this embodiment comprises two pairs instead of one pair of stabs 14 and an adjusting member 8 having a substantial U-shaped cross-section for being received within the channel 11 for adjusting the size of the channel 11 for receiving a cable 5 of an insufficient thickness such as 16 AWG or 18 AWG. As illustrated in FIGS. 11 to 12 and 15, the adjusting member 8 can simply be placed in the channel 11 and then the cable 5 can be placed in the adjusting member 8.

The above embodiments are preferred embodiments of the present invention. The present invention is capable of other embodiments and is not limited by the above embodiments. Any other variation, decoration, substitution, combination or simplification, whether in substance or in principle, not deviated from the spirit of the present invention, is replacement or substitution of equivalent effect and falls within the scope of protection of the present invention.

What is claimed is:

1. An electrical connector for electrical communication between a power cable and an electrical device comprising a tubular housing, one end of which having a longitudinal channel for receiving the power cable as defined by the flanges one on each side having a threaded radically outward surface, and the other end of which having a receptacle for receiving a two-pin or three-pin plug of the electrical device and after plugging the two electrically conductive contacts of the plug each connects to one or more stabs which are electrically conductive and extend from the channel for piercing the power cable; and a cap having a threaded interior surface for engaging with the threaded outward surfaces of the flanges and having a pressing member attached onto the interior bottom surface of the cap for being received within the channel for pressing against the cable in the channel.

2. The electrical connector as in claim 1, wherein it further comprises a connecting member, one end of which is attached onto the housing and the other end of which is attached onto the cap for avoiding the cap from being misplaced or otherwise lost, and the length of which is sufficient to allow the cap to be separated from the housing by screwing.

3. The electrical connector as in claim 1, wherein it further comprises a fastening ring which is disposed with a threaded interior surface surrounding the other end of the housing. The receptacle at the other end of the housing is disposed with a threaded outward surface for engaging with the threaded interior surface of the fastening ring such that the fastening ring moves downward to cover a section of the cable of the electrical device after its plug is being plugged into the receptacle for avoiding accidental disconnection and for making the connection weatherproof.

4. The electrical connector as in claim 1, wherein it further comprises an adjusting member having a substantial U-shaped cross-section for being received within the channel for adjusting the size of the channel for receiving a cable of an insufficient thickness.

5. The electrical connector as in claim 1, wherein more than one electrical connectors are connected to the power cable to form a power supply system to supply electricity to the electrical devices each of which is connected to one of the electrical connectors.
